(19) United States
(12) Patent Application Publication
(10) Pub. No.: US 2002/0002452 A1
(43) Pub. Date: Jan. 3, 2002

(54) Network-based text composition, translation, and document searching

(76) Inventors: Samuel T. Christy, North Cambridge, MA (US); Oren H. Levine, Waltham, MA (US); Eric J. Pierce, Framingham, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/819,456

(22) Filed: Mar. 28, 2001

Related U.S. Application Data
(60) Provisional application No. 60/192,663, filed on Mar. 28, 2000.

(51) Int. Cl. G06F 17/28; G06F 17/30

(52) U.S. Cl. 704/3; 704/8; 707/5

(57) ABSTRACT

Network-based communication, language translation, and content searching utilize a “pivot” or intermediate language that is readily translated into any of numerous natural languages. Web users may specify a desired language, and that selection is automatically detected by Web servers, which provide content in accordance therewith. In a search context, documents are archived in the pivot language, which serves as an intermediate representation enforcing a precise mode of expressing concepts. Word-match searches based on queries that have also been formulated in the pivot language will retrieve relevant documents with a high degree of reliability, since the concept of interest has been more rigorously formulated. Information in the form of text or messages may be broadcast or sent to recipients, who receive the information in a desired language regardless of the source language of the original information.

### RELATED APPLICATION

This application claims the benefits of U.S. Provisional Application Ser. No. 60/192,663, filed on Mar. 28, 2000.

### BACKGROUND OF THE INVENTION

The Internet is a worldwide “network of networks” that links millions of computers through tens of thousands of separate (but intercommunicating) networks. Via the Internet, users can access tremendous amounts of stored information and establish communication linkages to other Internet-based computers. Yet despite the Internet's global reach, it is not a truly “international” medium; traditional language barriers hamper the transnational accessibility of much available information.

At the present time, proprietors of Internet sites seeking to reach a multi-lingual audience must create separate versions of their content. For example, sites on the World Wide Web (hereafter, the Web) may contain duplicate sets of Web pages each in a different language and separately accessible by site visitors. The site may first serve an introductory page in mostly graphical form that offers the visitor a choice of languages for further pages. The visitor's selection dictates a sequence of links to pages expressed in the chosen language. This is obviously a cumbersome arrangement involving translation expenses, additional server capacity, and the need to individually maintain and update—in different languages—multiple sets of redundant pages. Indeed, because of these very difficulties, few sites offer more than a few language alternatives.

Translation is difficult for numerous reasons, including the lack of one-to-one word correspondences among languages, the existence in every language of homonyms, and the fact that natural grammars are idiosyncratic; they do not conform to an exact set of rules that would facilitate direct, word-to-word substitution. These problems also affect applications involving information retrieval. For example, commercial search engines allow Internet users to access huge reservoirs of documents based on user-generated search queries. The search engine retrieves documents matching the query, often ranked in order of relevance (e.g., in terms of the frequency and location of word matches or some other statistical measure).

Unfortunately, the vagaries of language frequently result in missed entries (due to synonymous ways of expressing the relevant concept) or, even more frequently, a flood of irrelevant entries (due to the multiple unrelated meanings that may be associated with words and phrases). For example, someone interested in military activities in China might attempt to search using the query “troops in China.” But because of the numerous and varied topics that may implicate virtually any chosen set of words, the search engine might retrieve documents containing the following sentences:

1. President plans meeting with leaders of China to talk about US troops in Taiwan.

2. Troops in Russia improve border security with China.

3. Leader of NATO troops in Bosnia to visit China.

4. Farmer finds crashed WWII troop carrier in southern China.

5. CIA papers reveal US troops in Cambodia near border of China during Vietnam War.

6. Asia expert, Johnson, talks to leaders of US troops about new weapons factories in China.

7. British troops in Hong Kong have mixed reaction to handover of Hong Kong to China.

8. Troops in controversy over design for new china.

9. Troops wear boots made in China.

10. Troops of General Chun put down protest in China.

Of course, only the last item is relevant to the user's intent.

### SUMMARY OF THE INVENTION

The present invention affords network-based translation and searching using a “pivot” or intermediate language that is readily translated into any of numerous languages. In a translation context, Web users specify a desired language, and that selection is automatically detected by Web servers, which provide content in accordance therewith. In a search context, documents (or portions thereof) are archived in the pivot language, which serves as an intermediate representation enforcing a precise mode of expressing concepts. Word-match searches based on queries that have also been formulated in the pivot language will retrieve relevant documents with a high degree of reliability, since the concept of interest has been more rigorously formulated.

For purposes hereof, it is useful to distinguish between a constrained natural-language grammar and a pivot language. The former is a set of rules or allowed linguistic constructions that limits the number of ways a thought may be expressed in a natural language. These rules are formulated for applicability across languages, so that expressions conforming to the grammar in one language are linguistically equivalent to corresponding expressions in other languages. A pivot language, in accordance with the present approach, facilitates translation by means of direct substitution of entries (e.g., by database lookup of equivalent words and/or terms).

A constrained natural-language grammar may serve as a pivot language so long as certain conditions are met. First, because translation occurs by substitution without analysis of meaning, all ambiguity relating to connotation must be resolved. For example, in a given language, the same word may have multiple meanings; in order to determine the intended meaning (and, therefore, the proper word or phrase to substitute in the target language), an author must select among the possible meanings before translation occurs. Second, the constrained grammar must be completely language-neutral so as to be applicable, without adaptation, to every supported language. Although this is possible, the requirement of conformity to all supported languages operates to limit the range of acceptable constructions in any particular language. As a result, the constrained grammar becomes that much farther removed from any particular natural language.

One suitable pivot language is disclosed in U.S. Pat. No. 5,884,247 (issued Mar. 16, 1999) and U.S. Pat. No. 5,983,221 (issued Nov. 9, 1999), the entire disclosures of which are hereby incorporated by reference. These patents set forth an approach in which natural-language sentences are represented in accordance with a constrained grammar and vocabulary structured to permit direct substitution of linguistic units in one language for corresponding linguistic units in another language. The vocabulary may be represented in a series of physically or logically distinct databases, each containing entries representing a form class as defined in the grammar. Translation involves direct lookup between the entries of a reference sentence and the corresponding entries in one or more target languages.

In accordance with the '247 and '221 patents, sentences may be composed of “linguistic units,” each of which may be one or a few words, from the allowed form classes. The list of all allowed entries in all classes represents the global lexicon, and to construct an allowed sentence, entries from the form classes are combined according to fixed expansion rules. Sentences are constructed from terms in the lexicon according to four expansion rules. In essence, the expansion rules serve as generic blueprints according to which allowed sentences may be assembled from the building blocks of the lexicon. These few rules are capable of generating a limitless number of sentence structures. This is advantageous in that the more sentence structures that are allowed, the more precise will be the meaning that can be conveyed within the constrained grammar. On the other hand, this approach renders computationally difficult the task of checking user entries in real time for conformance to the constrained grammar.

Alternatively, as described in copending application Ser. No. 09/405,515, filed on Sep. 24, 1999 (and hereby incorporated by reference), the constrained grammar may be defined in terms of allowed sentence types (rather than in terms of expansion rules capable of generating a virtually limitless number of sentence types). In this way, it is possible to easily check user input (word by word, or in the form of an entire document) for conformance to the grammar, and to suggest alternatives to sentences that do not conform.

Both approaches represent highly constrained natural-language grammars that provide the basis for a pivot language; each is capable of expressing the thoughts and information ordinarily conveyed in a natural grammar, but in a structured format amenable to automated translation.

For the reasons noted above, it may be preferable to distinguish between a constrained grammar and a pivot language. That is, authors may be more comfortable entering text according to a constrained grammar that “looks” like a natural language—i.e., which respects certain language-specific conventions so as to be reasonably comprehensible—and which is subsequently transformed into the pivot language. The basic translation is performed (invisibly to the author) by direct word/phrase substitution within the pivot-language representation, and the result is then transformed into the constrained grammar associated with the target natural language; the constrained-grammar translation may be presented directly, or may be further processed into conformity with the target natural language for maximum comprehensibility.

For example, in accordance with the '515 application, the use of allowed sentence-structure “templates” allows for provision of language-specific terms and/or modifications that are required by the nature of the construction. Thus, the system may utilize internal and external representations of the structures:

| Internal Rep. | English Rep. | Japanese Rep. | | |
|---|---|---|---|---|
| NC VTRA NC | She buys bread | Kanoja wa | pan o | kaimashita |
| | | She | bread | buys |
| | NC VTRA NC | NC (wa) | NC (o) | VTRA |

“Wa” represents a subject marker and “o” represents a subject marker. As explained in the '515 application, NC and VTRA refer to specific grammatical constructs, namely, a nominal construction (i.e., a phrase connoting, for example, people, places, items, activities or ideas) and VTRA refers to a transitive verb, so NC VTRA NC refers to a construction that includes a nominal construction followed by an intransitive verb followed by another nominal construction.

The pivot language is represented by language-neutral constructions such as NC VTRA NC, while the highly constrained natural-language grammar includes language-specific concepts such as, in the case of Japanese, “wa” and “O.” In the pivot language, translation may be accomplished by direct word/phrase substitution; translation into and out of the pivot language is accomplished according to structure-specific rules tailored to each supported language— i.e., in accordance with the constrained natural-language grammar. A translation system in accordance with the invention may therefore consult and implement the language-specific rules associated with a given sentence structure and language prior to and following word substitution.

In a first aspect of the invention, various elements of a Web site are expressed and stored, on the server, in the pivot language. The amount of content stored in the pivot language depends on the application. For example, the pivot-language content may encompass the entire site, specific pages of the site, specific sections of specific pages, or specific languages. In a preferred approach, Web pages are expressed as XML documents including attributes relevant to the pivot language. For example, XML-represented content (which may be displayed as a Web page) can include grammatical structures, identifiers for different meanings of the same word or word-concept, and other attributes (e.g., a set of expansion rules or allowed sentence structures) useful in performing translation.

When the server receives a request for a page, it determines the language in which the information is to be delivered, and sends the page with text in the appropriate language. In one approach, involving “on-the-fly” translation, the content of the Web site is stored once in the pivot language. Each time a browser requests information, text is converted into the designated language of the visitor and transmitted. Consequently, translation occurs in response to each received request.

Another approach utilizes a cache of pre-translated versions of the Web content (or portions thereof), which are stored in a format such as HTML. The pre-translated versions are generated from the content stored in the pivot language, as described above. When a browser requests information, the pre-translated HTML document is provided. In accordance with this approach, the pre-translated content remains static until there is a change in the pivot-language version of the Web content.

In another aspect, the invention offers query-based access to electronically accessible documents. These documents may be fully represented in the pivot language, or may be provided with abstracts written in the pivot language. The pivot language is capable of expressing the thoughts and information ordinarily conveyed in a natural grammar, but in a structured format that restricts the number of possible alternative meanings. Accordingly, while the grammar is clear in the sense of being easily understood by native speakers of the vocabulary and complex in its ability to express sophisticated concepts, sentences are derived from an organized vocabulary according to fixed rules.

A query, preferably formulated in accordance with (or transformed into) the pivot language, is employed by a search engine in the usual fashion. Due to the highly constrained meaning of such a search query, it is possible for a machine to determine an exact relationship between all of the words in the sentence. It is then possible to match the relationship of the words in a search query to the relationship of the words in a target of document, instead of simply relying on a general word match. If relevant documents contain similar word relationships, the query is readily used to identify the most relevant documents merely by examination of document contents and/or headers. This approach improves on conventional key-word searching by avoiding the irrelevant retrievals attributable to matches with words having multiple meanings and to ambiguously formulated queries.

In still another aspect, the invention facilitates communication of information in the form of text or messages, which may be broadcast or sent to recipients in a manner that allows them access to the information expressed in a desired natural language regardless of the source language of the original information.

### BRIEF DESCRIPTION OF THE DRAWINGS

The foregoing discussion will be understood more readily from the following detailed description of the invention, when taken in conjunction with the accompanying drawings, in which:

FIG. 1 is a schematic representation of a hardware system embodying the invention; and

FIG. 2 is a workflow diagram showing the general operation of some aspects of the invention;

FIG. 3 is a block diagram illustrating a search implementation of the invention;

FIG. 4 is a block diagram illustrating an information composition and broadcast system in accordance with the invention; and

FIG. 5 is a block diagram illustrating an information composition and broadcast system in accordance with the invention.

### DETAILED DESCRIPTION OF AN ILLUSTRATIVE EMBODIMENT

1. Basic Hardware Implementation

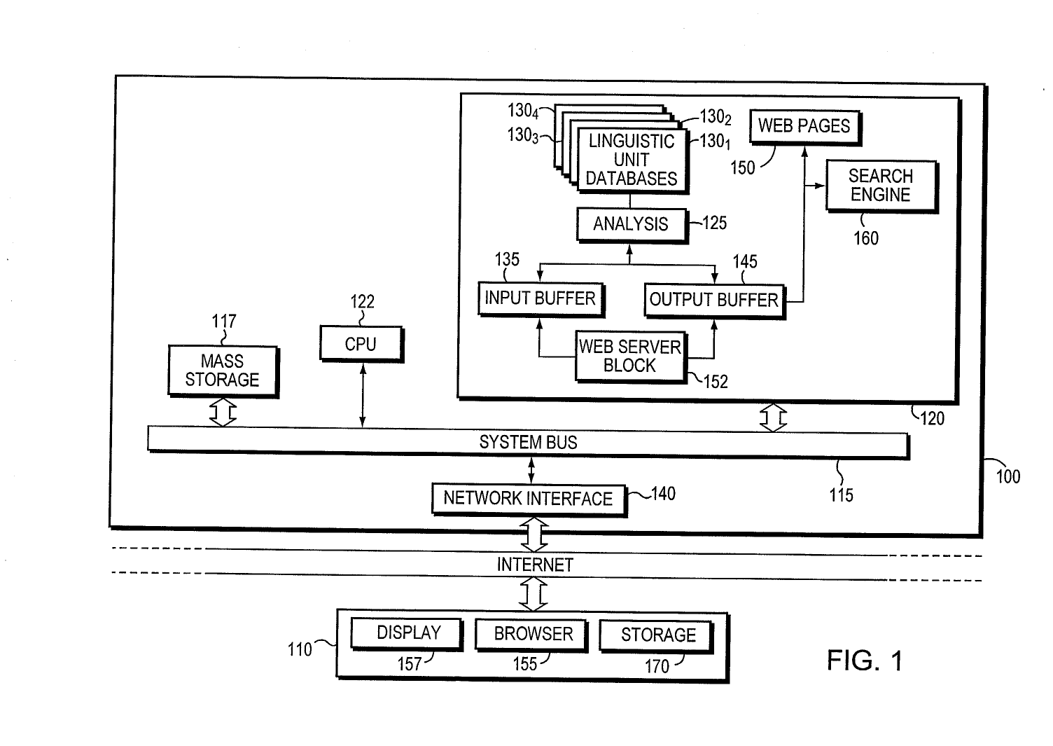

With reference to FIG. 1, a representative implementation of the invention involves a server 100 and a client computer 110, which communicate over a medium such as the Internet. The server 100, which generally implements the functions of the invention, is shown in greater detail. The components of server 100 intercommunicate over a main bidirectional bus 115. The main sequence of instructions effectuating the invention, as well as the databases discussed below, reside on a mass storage device (such as a hard disk or optical storage unit) 117 as well as in a main system memory 120 during operation. Execution of these instructions and effectuation of the functions of the invention is accomplished by a central-processing unit (“CPU”) 125.

The executable instructions that control the operation of CPU 122 and thereby effectuate the functions of the invention are conceptually depicted as a series of interacting modules resident within memory 120. (Not shown is the operating system that directs the execution of low-level, basic system functions such as memory allocation, file management and operation of mass storage devices 117.) An analysis module 125 directs execution of the primary functions performed by the invention, as discussed below, and interacts with one or more databases capable of storing the linguistic units of the invention; these are representatively denoted by reference numerals 130₁, 130₂, 130₃, 130₄. Databases 130, which may be physically distinct (i.e., stored in different memory partitions and as separate files on storage device 117) or logically distinct (i.e., stored in a single memory partition as a structured list that may be addressed as a plurality of databases), may contain all of the linguistic units corresponding to a particular class in one or more languages. In a translation context, each database is organized as a table each of whose columns lists all of the linguistic units of the particular class in a single language, so that each row contains the same linguistic unit expressed in the different languages the system is capable of translating.

An input buffer 135 receives from a remote user, via client machine 110, a textual input for translation, Web-page development, or search processing. Communications between server 100 and one or more client machines 110 ordinarily take place over a computer network. A network interface 140 provides programming to connect with the network, which may be a local-area network (“LAN”), a wide-area network (“WAN”), or, as illustrated, the Internet. Network interface 152 contains data-transmission circuitry to transfer streams of digitally encoded data over the communication lines defining the computer network.

Analysis module 125 may scan text received from client 110 for conformance to a constrained natural-language grammar (which may or may not ultimately serve as a pivot language, as explained previously). Specifically, each inputted sentence is treated as a character string, and using language-specific string-analysis routines, module 125 identifies the separate linguistic units and the expansion points. It then compares these with templates corresponding to the allowed structures to validate the sentence. As described below, analysis module 125 may include editing capability that highlights nonconforming sentence components and/or suggests alternatives. Analysis module 125 also interacts with the client user to perform disambiguation, also described in greater detail below, to refine and specify meanings.

Server 100 may be configured for simple translation or, more relevant to the present context, translation in aid of creating Web pages. In this case, module 125 processes single linguistic units or structural components of each inputted sentence in an iterative fashion, addressing the databases 130 to locate the corresponding entries in the given language, as well as the corresponding entries in the target language. Analysis module 125 translates the sentence by replacing the input entries with the entries from the target language, entering the translation into an output buffer 145. (It must be understood that although the modules of main memory 120 have been described separately, this is for clarity of presentation only; so long as the system performs all necessary functions, it is immaterial how they are distributed within the system and the programming architecture thereof.) This process allows the remote user to create a Web page in which content is expressed in the pivot language, enabling the page to be provided in a requested language.

Thus, memory 120 will ordinarily contain modules that confer the capability of communicating over the Web. As is well understood in the art, communication over the Internet is accomplished by encoding information to be transferred into data packets, each of which receives a destination address according to a consistent protocol, and which are reassembled upon receipt by the target computer. A commonly accepted set of protocols for this purpose includes the Internet Protocol, or IP, which dictates routing information; and the transmission control protocol, or TCP, according to which messages are actually broken up into IP packets for transmission for subsequent collection and reassembly. The Internet supports a large variety of information-transfer protocols, and the Web represents one of these. Web-accessible information is identified by a uniform resource locator or “URL,” which specifies the location of the file in terms of a specific computer and a location on that computer. Any Internet “node”—that is, a computer with an IP address—can access the file by invoking the proper communication protocol and specifying the URL. Typically, a URL has the format http://<host>/<path>, where “http” refers to the HyperText Transfer Protocol, “host” is the server's Internet identifier, and the “path” specifies the location of the file within the server. A Web server recognizes http messages and effects transmission of Web pages in response to requests.

Data exchange is typically effected over the Web by means of Web pages, and server 100 may be configured as a Web site offering its pages in different languages. In this case storage device 117 contains various aspects of the site's Web pages (which comprise formatting or mark-up instructions and associated data, and/or so-called “applet” instructions that cause a properly equipped remote computer to present a dynamic display) represented in the pivot language. The amount of site content stored in the pivot language may encompass the entire site, specific Web pages 150, portions of specific Web pages 150, or specific languages. Management and transmission of selected (or internally generated) Web pages 150 is handled by a Web server module 152, which allows the system to function as a Web (http) server.

The markup instructions are executed by an Internet “browser” 155 running on client computer 110 (which communicates with server 100 via the Web). These markup instructions determine the appearance of the Web page on the browser, which the client user views on a display 157.

To facilitate communication of Web pages in a language designated by the client user, Web pages may be expressed as XML documents including attributes relevant to the pivot language. When server 100 receives a request from client 110 for a page 150, the server determines the language in which the information is to be delivered, and sends the page with text in the appropriate language. Most simply, the Web pages 150 defining the site is stored only in the pivot language. Each time one of the Web pages 150 is requested by a remote client 110, text is converted into the appropriate language and the page 150 transmitted. In this implementation, translation occurs in response to each received request.

Another approach caches pre-translated versions of the Web content (or portions thereof) on device 117 in several languages, and in a format such as HTML. The pre-translated versions are generated from Web-page content stored in the pivot language. When a browser requests information, server 100 determines the desired language and, if the Web page has been pre-translated into that language, server 100 transmits the appropriate pre-translated HTML document. In accordance with this approach, the pre-translated content remains static until there is a change in the pivot-language version of the Web content (which may itself be represented as XML documents). Once a change is made to this version, the pre-translated HTML documents are regenerated from the content stored in the pivot language. This is particularly straightforward using the lookup-and-substitute approach set forth in the '247 patent and the '515 application. For example, if an author decides to change a single sentence in the pivot-language XML document on his site, this change can be instantly reflected in the stored language-specific HTML documents through the regeneration process.

Language selection in accordance with the present invention can be accomplished in various ways. Most simply, browser 155 may permit the client user to specify a language; for example, using the NETSCAPE NAVIGATOR browser, a desired language may be specified under Preferences/Navigator/Languages. When a Web page resident on server 100 is selected by the client user, server 100 extracts the specified language preference from browser 155 in the course of serving the page. In another approach, the preference is stored as a “cookie” in a storage component 170 on the client machine 110; in the course of interacting with client 110, server 100 accesses the cookie to determine the language selection. (As understood in the art, a cookie is a packet of information sent by an http server to a Web browser and then sent back by the browser each time it accesses that server. Cookies can contain any arbitrary information the server chooses and are used to maintain state between otherwise stateless http transactions.)

If the server is unable to determine the desired language, the Web page can directly ask the client user to specify one, and the selection is transmitted back to server 100. In any case, the client user's preference (whether extracted or provided) can be stored on server 100 for future use—during the current session as the visitor migrates from page to page, or for subsequent sessions through a cookie or association with an identifier for the visitor.

To build pivot-language content, the author of the Web site's pages may use an editor and compose text directly in the pivot language (or, more typically, in the highly constrained grammar that is subsequently converted into the pivot language). The necessary functions for translating from the author's native language into the pivot language are described in U.S. Ser. No. 09/457,050 filed on Dec. 7, 1999 (hereby incorporated by reference). Key to the operation of this type of system is detection and evaluation of terms having possible ambiguity using, as a basis, the attributes of a constrained grammar and a structured vocabulary. In this way, as text is submitted, the author is prompted to assign intended meanings to ambiguous terms, and the rules governing the constrained grammar are applied or enforced.

A similar scheme can be employed to facilitate searching in multiple natural languages or in the pivot language. As explained in the '221 patent and the '385 application, the use of a constrained grammar is helpful in document searching because it ensures that word meanings have been clarified, thereby reducing the ambiguity that can result in numerous irrelevant retrievals. In this case, documents (or portions thereof, or their abstracts or headers) are stored in the pivot language, and the querying visitor is treated as the author of a text: analysis module 125 scans his query for conformance to the constrained grammar, and he is prompted to clarify—i.e., to disambiguate—search terms having multiple meanings. The edited search query is then applied to an index derived from the corpus of documents (or the portion of such documents represented in the constrained grammar), and documents matching the query returned to the visitor in the manner of a typical search engine. In particular, a search engine 160 may be resident on server 110 (as illustrated) or located elsewhere, i.e., on a different server with which server 100 communicates.

Maintaining the entire document in the pivot language facilitates not only accurate searching but also ready translation into different languages. Thus, enhanced searching capability can be combined with ready translation. Moreover, in such a system the visitor's query can be entered in any language, since the editing process converts it into the pivot language in which the searchable portions of the document corpus are represented.

In accordance with this arrangement, the searchable text portions of documents may be maintained solely in the pivot language. If the entire text of each document is searchable, the document is desirably represented in the pivot language and translated on the fly (e.g., as the visitor requests documents identified in response to his search query). Alternatively, document text may also be maintained in one or more translated versions, with the appropriate version transmitted to the visitor based on an expressed language preference.

2. Pivot Language Representation and Disambiguation

In accordance with a preferred embodiment, text is represented at two levels: first in a language-specific, highly constrained grammar, and second in a language-neutral pivot language. Each level is desirably formatted in XML, using “tags” to characterize elements such as statements and field data. A tag surrounds the relevant element(s), beginning with a string of the form <tagname> and ending with </tagname>. For example, XML-represented content may include grammatical structures, identifiers for different meanings of the same word or word-concept, and other attributes (e.g., a set of expansion rules or allowed sentence structures) useful in performing translation.

The language-specific, highly constrained grammar is herein referred to as “Input XML,” and is exchanged between the client user (i.e., the text author) and server 100 during the process of composition and disambiguation. Text is provided to analysis module 125, which parses the text and represents it in Input XML, in the process identifying ambiguous words and phrases. The author is then presented with choices, each corresponding to a different meaning; selection of one of the choices “disambiguates” the text, and the author's choice replaces the original text. The language-neutral pivot content, herein referred to herein as “Output XML,” is utilized for purposes of translation and search.

3. Applications

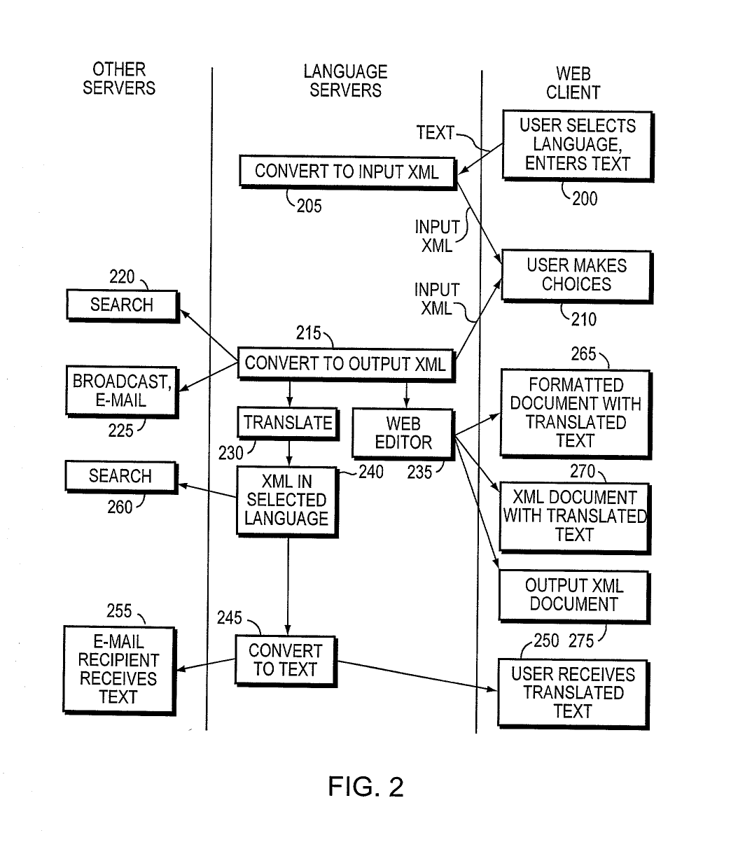

As shown in FIG. 2, the overall approach of the invention allows distribution of responsibility for translation and/or search functions so that existing facilities— such as Web portals, search engines, and e-mail systems—may obtain the benefits of the invention without directly supporting its functionality. In general, the user will not require special software to use the invention, instead communicating using his Web browser; alternatively, the user may be provided with an e-mail client configured to facilitate constrained-grammar editing and disambiguation. The user enters text and, in translation applications, specifies a preferred language (step 200). The user submits the text to a language server, which, through back-and-forth communication with the user, creates an Input XML representation of the user's text (steps 205, 210). The language server than converts the Input XML representation to Output XML (step 215), which may serve as a search query for external processing (step 220); may be broadcast or e-mailed (step 225); may be translated into another natural language (step 230); or passed to a Web editor to facilitate generation of Web content in Output XML (step 235).

In a translation scenario, the initial result of translation step 230 is creation of an Output XML representation. This representation may be completely language-neutral (e.g., a series of index references keyed to words and phrases in the databases for the supported languages, so that each reference facilitates retrieval of the corresponding word or phrase in any supported language), or may begin with Output XML entries in the input language followed by conversion, by database lookup, into XML entries in the target language (step 240). In either case, the XML entries may be converted to natural-language text (step 245) and provided to the user (step 250) or to an e-mail recipient (step 255). Alternatively, the XML (or the translated text) can provide the basis for a search of documents in the target language (step 260).

In one embodiment, the conversion step 245 is accomplished by straight-forward grammar processing directly from Output XML into the target natural language. In other embodiments, the Output XML construct is translated into XML in the target language, and the XML is then translated into the target natural language, used as the basis for a search in the target language, or employed for other purposes.

In a Web-page creation scenario, the Web page may be a formatted (e.g., HTML) document with translated text (step 265); an Input XML document expressed in multiple target languages (step 270); or an Output XML document that may be translated, when requested, on the fly.

Some of these applications will now be described in greater detail.

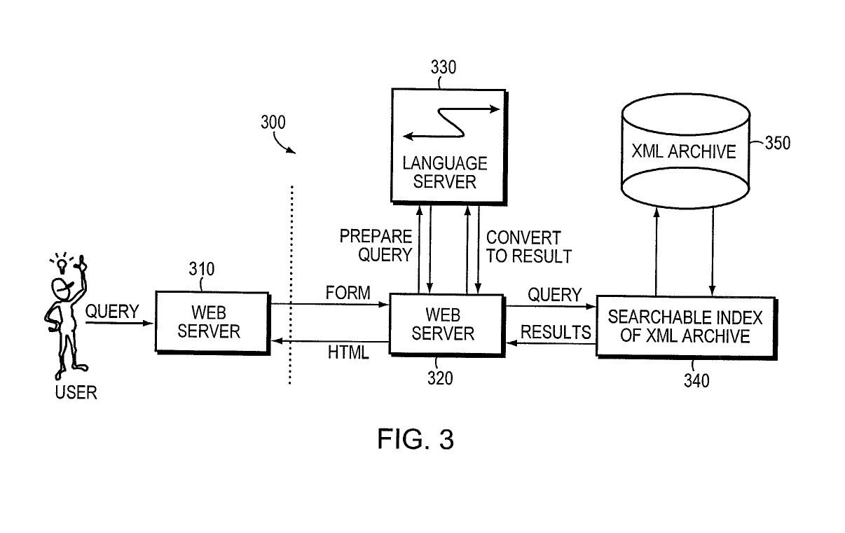

FIG. 3 illustrates an architecture 300 for a search application that demonstrates the manner in which tasks associated with the present invention can be distributed among physically distinct servers remotely located from one another. (In this and ensuing examples, the illustrated servers conform in terms of basic components to the configuration shown in FIG. 1, and include a CPU, mass storage, internal computer memory, a network interface, and executable instructions implementing the functions hereinafter described.) A Web user, interacting as a node on the Internet via a client machine 310, posts a search query on a blank form provided by a Web server 320. The query, which may be entered in a natural language (i.e., not in conformance with a constrained grammar), is transmitted to server 320 by routine functionality associated with the blank form. Web server 320 may be equipped to interact with the user (via Web pages) to disambiguate the query and bring it into conformity with the conventions of the constrained grammar. This is not necessary, however; the grammar functionality may instead be implemented on a second server 330. Thus, server 320 may be, for example, a Web portal or search engine. The user thereby obtains the benefits of the invention without burdening the proprietor of server 320 with the need to implement the functionality of the invention.

Moreover, server 320 need not even implement the basic searching capabilities. These may be implemented by a third server 340 devoted to document searching. Search server 340 may contain an index of documents containing text that conforms to the constrained grammar, or once again, may be a traditional search engine that accesses, upon user request, a document index 350 (generally part of search server 340 or connected to its local network, but possibly remote from server 340). For example, the constrained-grammar document index 350 may be maintained by the proprietor of server 330. In this way, the features of the invention fit seamlessly within existing capabilities and patterns of Web interaction, obviating the need to add invention-specific functionality to established Web sites. Thus, following processing into the constrained grammar, the user's query is sent by Web server 320 to search server 340, which performs the search and returns document identifiers to server 320 and, ultimately, to the user via client machine 310. In general, search server 340 will rank some or all of the documents containing matches in an order of relevance, the order favoring documents having constrained-grammar terms that literally match the processed search query.

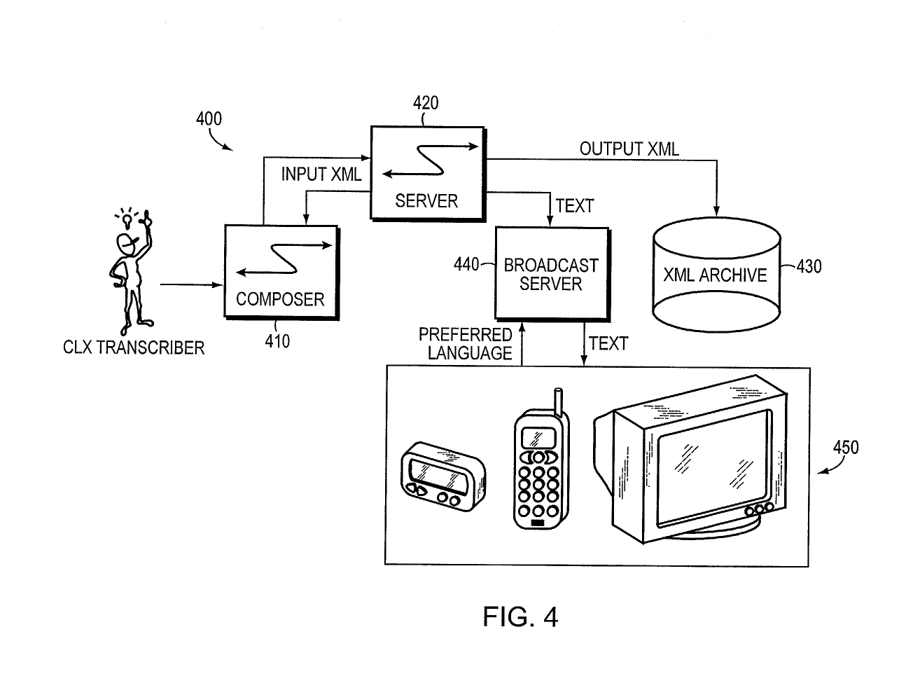

FIG. 4 shows an information composition and broadcast system 400 in accordance with the invention, illustrating the manner in which functionality can be distributed so that the user interacts with a simple, familiar interface. In particular, the user enters text into a “composer” or text-entry facility 410. This may be, for example, an application running directly on the user's client machine. The user, via composer 410, interacts with a server 420, which analyzes the entered text and causes it to conform to the constrained grammar associated with the language employed by the user. In addition, server 420 poses questions to the user as ambiguous words and phrases are detected, thereby allowing the user to disambiguate the text by specifying meanings as necessary.

When the text has been disambiguated, server 420 generates Output XML from the final Input XML representation. Since the Output XML represents translation-ready text, it may be archived on a storage device 430. Server 420 also translates the Output XML into one or more natural languages, transmitting the translation(s) to a broadcast server 440. Server 440, in turn, transmits the translation(s) (e.g., as text) to one or more receiving devices (e.g,. a pager, wireless telephone, computer, etc.) indicated generally at 450. A device 450 may communicate a preferred language to broadcast server 440, so that it receives the proper translation for its audience.

For example, the user may be a journalist entering text for an article into a laptop computer, which is in communication with server 420 via the Internet. As soon as the journalist's article is complete, he submits it to server 420 and interacts with the server until the article is fully disambiguated and may be transformed into Output XML. The decisions regarding the language(s) into which the article is to be translated, the manner in which (and persons to whom) the article is to be broadcast, and whether to archive the Output XML text may be made by the journalist's employer, which interacts with server 420 to effect these choices.

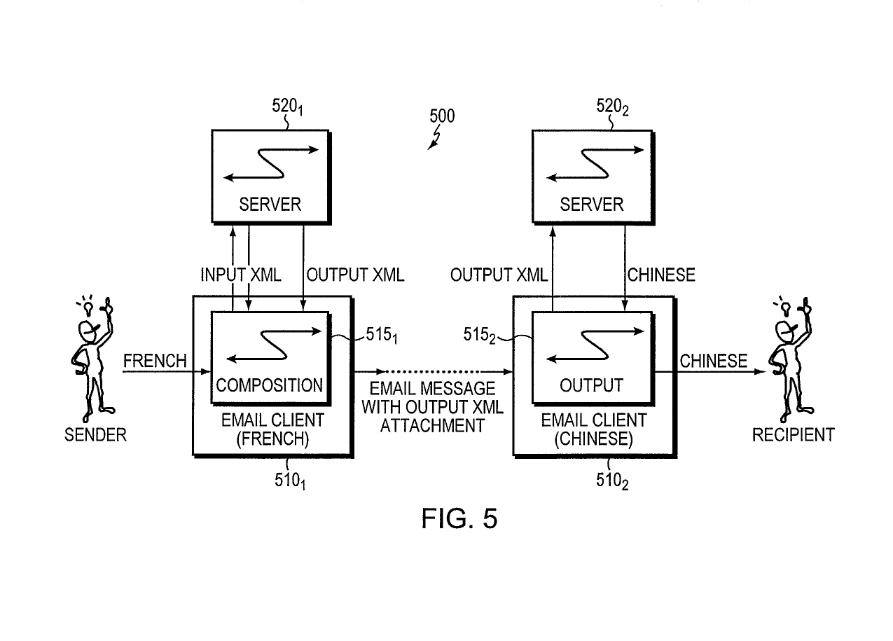

FIG. 5 illustrates the manner in which the invention can be applied to a conventional e-mail system. The e-mail sender and recipient each prepare and send e-mail on an a client computer 510₁, 510₂. Each client computer is connected to the Internet and runs an e-mail system 515₁, 515₂. When one of the users decides to send an e-mail to the other user, the e-mail sender types e-mail text into his system 515₁, in the usual fashion, and in his native language (e.g., French). However, before transmitting the e-mail to the recipient, the sender interacts with a server 520₁ (by e-mail or via the Web) to disambiguate the message and place it in conformity with Input XML. When this process is complete, server 520₁ converts the message to Output XML and passes it back to e-mail system 515₁. The sender thereupon causes the message to be transmitted to the recipient's e-mail system 515₂, which, in turn, sends the message to a translation server 520₂. Server 520₂ translates the Output XML into the recipient's chosen language (e.g., Chinese), which may be the language that the recipient has specified on his e-mail system 515₂ or his Web browser, and passes the translated message back to the recipient's e-mail system 515₂ for viewing. (Ordinarily, servers 520₁, 520₂ each implement both conversion and translation capabilities so that any user may be a sender or a recipient, and indeed, servers 520₁, 520₂ may be a single machine.)

The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. For example, the various modules of the invention can be implemented on a portable general-purpose computer using appropriate software instructions, or as hardware circuits, or as mixed hardware-software combinations.

What is claimed is:

1. A method of providing documents to a visitor to a Web site, the Web site comprising a plurality of browser-readable Web pages, at least some of the Web pages containing text portions represented in a pivot language, the Web site according access to a Web page by causing, in response to a request therefor, communication of the Web page to a requester's computer for presentation thereon, the method comprising the steps of:
a. determining a desired natural language for the requester;
b. receiving a Web-page selection from the requester's computer;
c. translating any text portions of the selected Web page from the pivot language into the desired natural language; and
d. communicating the translated selected Web page to the requester's computer.

2. The method of claim 1 wherein the requester's computer runs a Web browser as an active process and the desired language is entered in the Web browser, the desired natural language being determined through interaction with the browser.

3. The method of claim 1 wherein the requester's computer comprises a storage facility, the desired natural language being indicated on a cookie stored in the storage facility, the desired natural language being determined through interrogation of the cookie.

4. The method of claim 1 wherein each Web page is represented in multiple versions, the text portions of each version being expressed in a constrained grammar corresponding to a different language, the translating step comprising (i) selecting the Web-page version corresponding to the desired natural language and (ii) translating the text portions into the desired natural language.

5. The method of claim 1 wherein the pivot language is a language-independent constrained grammar convertible into natural languages and capable of translation among languages by direct substitution of words and phrases, each Web page being represented in a single version in which the text portions are expressed in the pivot language, the translating step comprising (i) translating the text portions into a form representative of the desired language by direct substitution of words and phrases, and (ii) converting the translated text portions into the desired natural language.

6. The method of claim 1 wherein the pivot language is a constrained grammar derived from one of a plurality of natural languages and convertible into constrained grammars derived from the other natural languages, the Web page being represented as an XML document including attributes relevant to the constrained grammar.

7. Apparatus for providing documents to a visitor to a Web site, the apparatus comprising:
a. a plurality of browser-readable Web pages defining the site, at least some of the Web pages containing text portions represented in a pivot language;
b. a Web server for receiving a request from the visitor for a Web page and, in response thereto, locating the Web page and communicating it to the visitor; and
c. a translation module responsive to a visitor-specified natural language for translating any text portions of the selected Web page from the pivot language into the desired natural language prior to communication of the Web page.

8. The apparatus of claim 7 wherein the visitor communicates with the Web site using a computer, the Web server interacting with a Web browser running as an active process on the visitor's computer, the desired natural language being entered in the Web browser, the Web server obtaining the desired natural language from the browser.

9. The apparatus of claim 7 wherein the visitor communicates with the Web site using a computer, the visitor's computer comprising a storage facility having the desired natural language indicated on a cookie stored therein, the Web server determining the desired natural language being through interrogation of the cookie.

10. The apparatus of claim 7 wherein the pivot language is a language-independent constrained grammar convertible into natural languages and capable of translation among languages by direct substitution of words and phrases, each Web page being represented in a single version in which the text portions are expressed in the pivot language, the translation module being configured to (i) translate the text portions into a form representative of the desired language by direct substitution of words and phrases, and (ii) convert the translated text portions into the desired natural language.

11. The apparatus of claim 7 wherein each Web page is represented in multiple versions, the text portions of each version being expressed in a constrained grammar corresponding to a different language, the translation module being configured to (i) select the Web-page version corresponding to the desired natural language and (ii) translate the text portions into the desired natural language.

12. The apparatus of claim 7 wherein the pivot language is a constrained grammar derived from one of a plurality of natural languages and convertible into constrained grammars derived from the other natural languages, the Web page being represented as an XML document including attributes relevant to the constrained grammar.

13. A method of searching for stored content, the method comprising the steps of:
a. facilitating entry of a natural-language search query by a user operating a client computer, the search query comprising a plurality of terms;
facilitating transmission, via a computer network, of the search query from the client computer to a language server;
c. facilitating conversion of the natural-language search query received by the language server into a constrained grammar through interaction, via the computer network, with the user, the interaction including disambiguation of the query terms; and
d. searching stored content items, at least a portion of each content item being expressed in the constrained grammar, for matches between the item constrained grammar and the converted search query.

14. The method of claim 13 further comprising the step of ranking at least some of the items containing matches in an order of relevance, the order favoring items having constrained-grammar terms that literally match the converted search query.

15. The method of claim 13 wherein the client computer interacts with the language server through communication, via the computer network, with a host server, the host server communicating via the computer network with the language server to facilitate the interaction.

16. The method of claim 15 wherein the host server performs the searching step.

17. The method of claim 15 wherein the searching step is performed by a search server communicating, via the computer network, with the host server.

18. A method of facilitating information composition and broadcast, the method comprising the steps of:
a. facilitating entry of a natural-language text composition by a user operating a client computer;
b. facilitating transmission, via a computer network, of the text composition from the client computer to a language server;
c. facilitating conversion of the text composition received by the language server into a pivot language through interaction, via the computer network, with the user, the interaction including disambiguation of the text composition;
d. facilitating designation of a desired natural language by a receiving device;
e. causing the language server to translate the converted text composition from the pivot language into the desired natural language; and
f. causing transmission of the text composition in the desired natural language to the receiving device via a communication medium.

19. The method of claim 18 wherein the transmission step is accomplished by a broadcast server in communication, via a computer network, with the language server, the receiving device communicating with the broadcast server to specify the desired natural language.

20. The method of claim 19 wherein the broadcast server receives from the language server a plurality of natural-language versions of the text composition including a version in the desired natural language, the broadcast server transmitting said version to the receiving device.

21. The method of claim 19 wherein the broadcast server identifies the desired natural language to the language server, which, in response, translates the converted text composition from the pivot language into the desired natural language and transmits translated text composition via a computer network to the broadcast server for transmission to the receiving device.

22. A method of facilitating electronic message exchange, the method comprising the steps of:
a. facilitating entry of a natural-language message by a user operating a client computer;
b. facilitating transmission, via a computer network, of the message from the client computer to a language server;
c. facilitating conversion of the message received by the language server into a pivot language through interaction, via the computer network, with the user, the interaction including disambiguation of the message;
d. facilitating designation of a desired natural language by a message recipient;
e. causing translation of the converted message from the pivot language into the desired natural language; and
f. making the message available to the recipient in the desired natural language.

23. The method of claim 22 wherein the recipient operates a client computer, the message being initially transmitted to the recipient's client computer in the pivot language, the recipient's client computer transmitting, via a computer network, the pivot-language message and the language designation to the language server, the language server translating the message into the desired natural language and transmitting the natural-language message via the computer network to the recipient's client computer.

24. The method of claim 22 wherein the recipient operates a client computer, the message being initially transmitted to the recipient's client computer in the pivot language, the recipient's client computer transmitting, via a computer network, the pivot-language message and the language designation to a second language server, the second language server translating the message into the desired natural language and transmitting the natural-language message via the computer network to the recipient's client computer.
